(19) United States
(12) Patent Application Publication
(10) Pub. No.: US 2026/0249281 A1
(43) Pub. Date: Aug. 27, 2026

(54) CONTINUOUS SYNTHESIS PROCESS OF NANOSIZED Y ZEOLITE

(71) Applicant: SAUDI ARABIAN OIL COMPANY, Dhahran (SA)

(72) Inventors: Lianhui DING, Dhahran (SA); Faisal M. ALOTAIBI, Dhahran (SA); Mohammad ALJISHI, Dhahran (SA)

(73) Assignee: SAUDI ARABIAN OIL COMPANY, Dhahran (SA)

(21) Appl. No.: 19/062,732

(22) Filed: Feb. 25, 2025

(51) Int. Cl. B01J 37/03; B01J 29/08; B01J 35/40; B01J 35/61; B01J 35/63; B01J 35/64; B01J 37/04; B01J 37/08; C01B 39/24

(52) U.S. Cl. CPC B01J 37/036; B01J 29/084; B01J 35/40; B01J 35/617; B01J 35/635; B01J 35/647; B01J 37/04; B01J 37/08; C01B 39/24; C01P 2006/12; C01P 2006/14; C01P 2006/16

(57) ABSTRACT

A method of producing a zeolite catalyst comprises mixing a basic solution with an aluminum/silicon mixture to form a basic aluminum solution, the aluminum/silicon mixture comprising a silicon source and an aluminum source; feeding the basic aluminum solution into a first reactor to form a hydrogel, at a temperature from 20° C. to 40° C. for a residence time from 1 hour to 30 hours; crystallizing the hydrogel in a second reactor to form zeolite crystals at a temperature from 50° C. to 70° C. for a residence time of 12 hours to 24 hours; and transferring the zeolite crystals to a third reactor having a third reaction temperature of 80° C. to 100° C. for a residence time of 12 hours to 24 hours.

### FIELD OF THE DISCLOSURE

The present disclosure relates generally to synthesis of zeolite catalysts. More specifically, the disclosure relates to utilizing a three-reactor system of a specific length to diameter ratio to produce Y type zeolite catalysts.

### BACKGROUND OF THE DISCLOSURE

With the ongoing depletion of light crude oil and increasing demand for clean fuel and petrochemicals, more heavy oils need to be converted. Hydrocracking is one of the most efficient processes for heavy oil conversion.

The catalysts used in the hydrocracking process have two functions, cracking of high molecular weight hydrocarbon and hydrogenating the unsaturated molecules. The most widely used catalysts in hydrocracking are zeolites, specifically zeolite Y. However, the small pore size of the zeolite does not favor the diffusion of large molecules from the heavy oil fraction into active sites located inside the zeolite. This causes low activity, and a possible deactivation of the catalyst.

Zeolites are crystalline aluminosilicates with uniform nanometer-sized pores. Their unique frameworks and high internal surface areas make them widely used in chemical and petrochemical processes, such as production of fuels, fine chemicals and pharmaceuticals synthesis, pollution abatement, membranes, membrane reactors, sensors, and optoelectronic materials.

Conventionally, nano-sized zeolites are synthesized batch by batch. However, this process is time and energy intensive due to heating and cooling reactors for each batch synthesis. Additionally, due to the multiple processes, each batch may lack uniformity. While research has been directed towards a continuous process, the overall results have not been promising due to low yield and lack of uniformity.

Accordingly, a need exists for synthesis of nano-sized zeolites in high yield and/or high uniformity.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method of producing a zeolite catalyst comprises mixing a basic solution with an aluminum/silicon mixture to form a basic aluminum solution, the aluminum/silicon mixture comprising a silicon source and an aluminum source; feeding the basic aluminum solution into a first reactor to form a hydrogel, at a temperature from 20° C. to 40° C. for a residence time from 1 hour to 30 hours; crystallizing the hydrogel in a second reactor to form zeolite crystals at a temperature from 50° C. to 70° C. for a residence time of 12 hours to 24 hours; and transferring the zeolite crystals to a third reactor having a third reaction temperature of 80° C. to 100° C. for a residence time of 12 hours to 24 hours.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 depicts a first reactor configuration for synthesis of nano-sized Y zeolite.

FIG. 2 depicts a second reactor configuration for synthesis of nano-sized Y zeolite.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Zeolite Y is a type of synthetic zeolite, which is a crystalline aluminosilicate material with a highly ordered structure. Zeolite Y generally comprises a three-dimensional pore structure that is highly porous and stable.

An ongoing need exists to develop a continuous process to synthesize zeolites, such as zeolite Y. A continuous process may be more energy efficient by reducing the energy consumption required for repeated heat-up and cool-down of batch crystallizer reactors. Also, a continuous process may produce a more uniform product because of readily controlled operating conditions. Further, continuous synthesis may increase the synthesis capacity, may increase product yield by reducing the loss of handling intermediates (e.g., when transferring from one vessel to another), and may permit improved oversight of product quality.

The poor diffusion efficiency of bulky molecules discussed above may be ameliorated by reducing the zeolite particle size. Reduced particle size may increase external surface area and shorten the diffusion path of molecules.

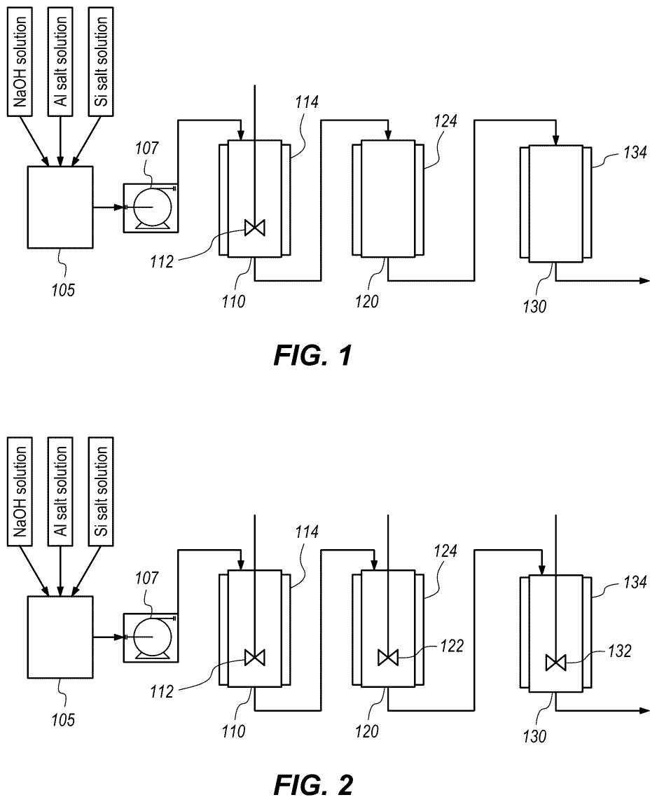

Methods of producing zeolite catalysts may include mixing a basic solution with an aluminum/silicon solution to form a basic aluminum solution, followed by the use of multiple reactors for zeolite crystal growth. Schematic representations of systems that may be used in the methods are shown in FIG. 1 and FIG. 2. Particular embodiments of the methods will be described with reference to the figures.

The aluminum/silicon solution may include a silicon source (e.g., silica or a silicate) and an aluminum source. Mixing may be performed in a mixing tank 105 or other suitable apparatus.

In some embodiments, the basic aluminum solution comprises a molar ratio of hydroxide ions to aluminum to silicon of (5 to 20):(1-3):(10-30). In various embodiments, the molar ratio of hydroxide ion to aluminum to silicon is (8 to 12):(1):(14).

In some embodiments, the aluminum/silicon solution comprises Al(NO₃)₃ or Al₂(SO₄)₃ and silica (silicon dioxide) or a silicate. In some embodiments, the aluminum/silicon solution may include silica.

The basic solution may include a metal hydroxide, for example, sodium hydroxide. The basic solution may include tetramethylammonium hydroxide (TMAOH). In some embodiments, the basic solution does not include an ammonium cation.

The basic aluminum solution may be fed from mixing tank 105 into first reactor 110, such as by the operation of pump 107. In first reactor 110, the basic aluminum solution may form a hydrogel. Conditions for forming a hydrogel in first reactor 110 may include a temperature from 20° C. to 40° C. The temperature may be held constant or may vary. For example, the reactor temperature may be held constant at a value between or vary between 25° C. to 35° C. or 20° C. to 30° C. The temperature of first reactor 110 may be maintained or adjusted by temperature control device 114. Conditions for forming a hydrogel in the first reactor 110 may also include a residence time from 1 hour to 30 hours, such as from about 15 hours to 30 hours or about 18 hours to about 30 hours. In some embodiments, the residence time in the first reactor 110 may be from 18 to 25 hours, 20 to 30 hours, or 15 hours to 30 hours. The residence time in the first reactor 110 may be controlled by the flow rate of the basic aluminum solution into the first reactor 110.

The first reactor 110 may also comprise a stirrer 112 or other agitation apparatus. Though not to be bound by theory, stirring or other agitation of the basic aluminum solution and/or the hydrogel in first reactor 110 may improve one or more properties of the zeolite crystals formed by the method.

The first reactor 110 allows for an aging step, and the first reactor 110 may be called an aging reactor. Aging is a step in the nucleation process of zeolite synthesis. The aging step may affect the crystallization process and the final product of the zeolite. In the aging reactor, zeolite nuclei may form, after which the second reactor 120 and third reactor 130 may allow crystallization, as will be discussed below. The aging reactor may allow the generation of more zeolite nuclei, which may be more easily crystallized to BeNano-sized zeolites (greater than about 0.3 nm) in the reactor 120 and 130. The second reactor 120 and third reactor 130 allow the zeolite nuclei to grow into larger nano-sized crystals. However, the nano-sized crystals may be further crystallized, and may grow to be larger crystals.

After aged hydrogel formation in the first reactor 110, the aged hydrogel may be fed to a second reactor 120, where zeolite crystals may form and/or grow at a temperature from 50° C. to 70° C. for a residence time of 12 hours to 24 hours. The temperature of second reactor 120 may be maintained or adjusted by temperature control device 124, e.g., a heater. The residence time in the second reactor 120 may be controlled by the flow rate of the hydrogel into the second reactor 120. Stirring or other agitation may be performed in the second reactor 120, such as by stirrer 122 (FIG. 2).

A solution containing zeolite crystals formed in the second reactor 120 may be transferred to a third reactor 130 having a third reaction temperature of 80° C. to 100° C. for a residence time of 12 hours to 24 hours. Under these conditions, zeolite crystals may further grow and may yield zeolites having properties, such as average particle size, crystallinity, surface area (m2/g), pore volume (mL/g), and/or average pore size comparable to zeolites formed by batch processes. Such zeolites may be useful in hydrocracking processes.

The temperature of third reactor 130 may be maintained or adjusted by temperature control device 134, e.g., a heater. The residence time in the third reactor 130 may be controlled by the flow rate of the solution into the third reactor 130. Stirring or other agitation may be performed in the third reactor 130, such as by stirrer 132 (FIG. 2).

In some embodiments, the volume of each of the one of more reactors 110, 120, and 130 is in the range of from 0.5 L to 1,000 L, such as in the range of from 20 L to 750 L, e.g., from 30 L to 250 L, or from 40 L to 90 L.

Independently of the absolute volumes of the reactors 110, 120, and 130, the volume ratio of the first reactor to the second reactor to the third reactor may be (1-30):(12-24):(12-24).

Each of the reactors 110, 120, and 130 may be a tubular reactor, a ring reactor, a stir reactor, and a continuously oscillating reactor, a plain tubular reactor, a tubular membrane reactor, a ring reactor, a continuously oscillating baffled reactor, and combinations thereof. In some embodiments, each of the continuous flow reactors is a plain tubular reactor and/or a ring reactor. In some further embodiments, each of the continuous flow reactors is a plain tubular reactor.

Each of the reactors 110, 120, and 130 may be straight and/or comprises one or more curves with respect to the direction of flow. For example, each of the one of more continuous flow reactors 110, 120, and 130 may be straight and/or have a coiled form with respect to the direction of flow. In some embodiments, each of the one of more continuous flow reactors 110, 120, and 130 has a coiled form with respect to the direction of flow.

Regardless of the conformation of any reactor 110, 120, or 130, the length of the flow path from a primary inlet to a primary outlet may be considered the length of the reactor, and the average distances between opposed points on the reactor's inner wall that are in a plane perpendicular to the line of flow may be considered the diameter of the reactor.

In embodiments wherein each of the one of more continuous flow reactors 110, 120, and 130 is straight and/or comprises one or more curves with respect to the direction of flow, it is preferred that the inner diameter of the curved form is in the range of from 6 to 100 mm, preferably from 7 to 80 mm, more preferably of from 8 to 60 mm, more preferably of from 9 to 40 mm, more preferably of from 10 to 25 mm, and more preferably of from 15 to 10 mm.

In some embodiments, each of the one of more reactors 110, 120, and 130 is a tubular reactor. Further, at least a portion of each tubular reactor may be of a regular cylindrical form having a constant inner diameter perpendicular to the direction of flow. In some embodiments, the inner diameter is in the range of from 5 mm to 250 mm, such as in the range of from 10 mm to 200 mm, e.g. from 15 mm to 150 mm, or from 20 mm to 75 mm. Alternatively or additionally, each of the one of more continuous flow reactors 110, 120, and 130 may have a length in the range of from 1 m to 50 m, such as in the range of from 2 m to 40 m, e.g. from 3 m to 30 m, 4 m to 20 m, or from 5 m to 10 m.

Independently of the absolute lengths and diameters of the reactors 110, 120, and 130, the first reactor, the second reactor, and the third reactor may each have a reactor length to diameter ratio from 20:1 to 100:1.

Zeolite crystals obtained from the third reactor 130 may be treated by one or more techniques prior to use in hydrocracking processes. Treatment may comprise one or more of solid-liquid separation, washing, drying, and calcining, among other techniques. In some embodiments, zeolite crystals obtained from the third reactor 130 are calcined at a temperature of 300° C. to 600° C.

The zeolite produced in the methods may include a silica to alumina molar ratio of 3 to 6. In some embodiments, the zeolite catalyst has an average particle size from about 500 nm to about 900 nm as measured by scanning electron microscopy (SEM). Alternatively or additionally, the zeolite catalyst may have a crystallinity of least 90%, such as up to about 95%, as measured by an X-ray diffraction (XRD). Further, the zeolite catalyst may have a surface area of at least 500 m²/g, a pore volume of at least 0.5 mL/g, such as up to 0.7 mL/g, and/or an average pore size of 2.0 nm to 5.0 nm.

One or more of the properties of zeolites produced by continuous synthesis as disclosed herein may be comparable to those of zeolites prepared by known batch synthesis techniques. In addition, the continuous synthesis process disclosed herein may improve the product yield, improve quality consistency, have higher throughput, and/or have lower energy costs than batch synthesis techniques or prior studies in continuous synthesis. The continuous synthesis process disclosed herein can produce nano-size or sub-micron sized zeolite Y.

### EXAMPLES

### Comparative Example C1—Batch Synthesis with Al(NO₃)₃ as Al Source

76 g NaOH and 360 g of water were added to a glass bottle. The NaOH was stirred until it dissolved. Then, 75 g Al(NO₃)₃·9H₂O and 210 g of 40 w % colloidal silica were added while stirring. After stirring for 1 hour, the solution was heated slightly to 30° C. Maintaining the temperature, the solution was stirred for 20 hour forming a hydrogel.

The hydrogel was autoclaved and crystallized at 60° C. for 12 hours. The temperature was increased to 100° C. for 12 hours. The products were filtered, washed, dried at 110° C. overnight and calcined at 500° C. for 4 hours (temperature increase 2° C./min).

### Comparative Example C2—Batch Synthesis with Al₂(SO₄)₃ as Al Source

76 g NaOH and 360 g of water were added to a glass bottle. The NaOH solution was stirred until the NaOH was dissolved. Then 66.6 g Al₂(SO₄)₃·18H₂O and 210 g of 40 w % colloidal silica were added while the solution was stirred for 1 hour. The solution was then heated to 30° C. and stirred at that temperature for 20 hours. The resulting hydrogel was autoclaved and crystallized at 60° C. for 12 hours. The temperature was then increased to 100° C. for 12 hours. The products were filtrated, washed, dried at 110° C. overnight, and calcined at 500° C. for 4 hours (temperature increase 2° C./min).

### Example 1—Continuous Synthesis with Al(NO₃)₃ as Al Source

76 g NaOH and 360 g of water were added to a beaker. The NaOH solution was stirred until the NaOH was dissolved. 75 g Al(NO₃)₃·9H₂O and 210 g of 40 w % colloidal silica were added under stirring, and the resulting mixture was transferred to a 2 L stainless-steel mix tank. Stirring was maintained throughout the process.

The mixture in the 2 L tank was pumped into an aging reactor with stir and maintained at 30° C. The aging reactor was 64 cm long, internal diameter was 2 cm, and total volume was 200 ml. The flowrate was controlled at 10 mL/hour, leading to a residence time of 20 hours, and a hydrogel was formed.

The hydrogel formed in the aging reactor was introduced to a low temperature crystallization reactor, which did not include a stirring mechanism. The reactor temperature was maintained at 60° C. Reactor properties included 40 cm length, 2 cm internal diameter, and total volume about 120 mL. The residence time was approximately 12 hours.

From the low temperature crystallization reactor, the sample was introduced to a high temperature crystallization reactor, which did not include a stirring mechanism. The reactor temperature was maintained at 100° C. The reactor properties included 40 cm length, 2 cm internal diameter, and total volume about 120 ml. The residence time was about 12 hours.

The product from the high temperature crystallization reactor was collected, filtrated, washed, dried at 110° C. overnight, and calcined at 500° C. for 4 hour (temperature increase 2° C./min).

### Example 2—Continuous Synthesis with Al₂(SO₄)₃ as Al Source

76 g NaOH and 360 g of water were added to a beaker. The solution was stirred until the NaOH dissolved. Then, 66 g Al₂(SO₄)₃·18H₂O and 210 g of 40 w % colloidal silica were added while stirring.

The basic aluminum solution was added to a 2 L stainless-steel mix tank with stirring. The basic aluminum solution was then pumped into an aging reactor with stir and maintained at 30° C. to form a hydrogel. The reactor had length 64 cm and internal diameter 2 cm. Total volume was 200 ml. The flowrate was controlled at 10 mL/hour, leading to a residence time of 20 hours.

The hydrogel was introduced to a low temperature crystallization reactor, which did not include a stirring mechanism. The reactor was maintained at 60° C. for 12 hours. The reactor properties included 40 cm length, 2 cm internal diameter, and a total volume of about 120 mL. The residence time was about 12 hours.

After the low temperature crystallization reactor, the sample was fed into a high temperature crystallization reactor, which did not include a stirring mechanism. The reactor was maintained at 100° C. The reactor properties included 40 cm length, 2 cm internal diameter, and a total volume about 120 mL. The residence time was about 12 hours.

The product was collected, filtered, washed, dried at 110° C. overnight, and calcined at 500° C. for 4 hour (temperature increase 2° C./min).

Characteristics of the four zeolites (Comparative Example C1, Comparative Example C2, Example 1, and Example 2) were determined by SEM, XRD, and the Brunauer-Emmett-Teller (BET) method and are tabulated in Table 1.

TABLE 1
Characteristics of the zeolites produced in
a batch reactor and a continuous reactor

| Sample name | C1 | C2 | Example 1 | Example 2 |
|---|---|---|---|---|
| Reactor Type | Batch | Batch | Continuous | Continuous |
| Bulk SiO2/Al2O3 molar | 4.7 | 5.1 | 4.7 | 5.2 |
| ratio | | | | |
| SEM particle sizes, nm | 511 | 739 | 504 | 740 |
| XRD crystallinity, % | 92 | 92 | 92 | 93 |
| Product yields, wt % | 65 | 68 | 87 | 88 |
| BET result | | | | |
| Surface area, m²/g | 636 | 697 | 650 | 700 |
| Pore volume, mL/g | 0.60 | 0.61 | 0.63 | 0.60 |
| Average pore size, nm | 3.8 | 3.5 | 3.9 | 3.4 |

As previously discussed, prior continuous flow reactors for the crystallization of zeolites have not been successful. Without being bound by theory, it is believed that due to the slow kinetics of crystallization, low flow rates were needed by prior reactors to obtain the required residence times. Additionally, low flow rates contributed to low mass and heat transfer rates such that the prior processes yielded non-uniform products and had poor energy efficiency.

The results tabulated in Table 1 indicate that the continuous reactor synthesis processes of Example 1 and Example 2 produced zeolites with similar properties and at roughly 20 wt % higher yield when compared to zeolites produced in batch reactors.

Embodiments disclosed herein include:
A. A method of producing a zeolite catalyst comprises mixing a basic solution with an aluminum/silicon mixture to form a basic aluminum solution, the aluminum/silicon mixture comprising a silicon source and an aluminum source; feeding the basic aluminum solution into a first reactor to form a hydrogel, at a temperature from 20° C. to 40° C. for a residence time from 1 hour to 30 hours; crystallizing the hydrogel in a second reactor to form zeolite crystals at a temperature from 50° C. to 70° C. for a residence time of 12 hours to 24 hours; and transferring the zeolite crystals to a third reactor having a third reaction temperature of 80° C. to 100° C. for a residence time of 12 hours to 24 hours.

Embodiment A may have one or more of the following additional elements in any combination:
Element 1: wherein the first reactor is a continuous stir reactor.
Element 2: wherein the basic solution comprises a metal hydroxide.
Element 3: wherein the basic solution comprises a molar ratio of hydroxide ions to aluminum to silicon (5 to 20):(1-3):(10-30).
Element 4: wherein the basic solution comprises sodium hydroxide.
Element 5: wherein the basic solution does not comprise an ammonium cation.
Element 6: wherein the aluminum/silicon mixture comprises Al(NO₃)₃ or Al(SO₄)₃ and silica or a silicate.
Element 7: wherein the residence time in the first reactor is from 18 to 30 hours.
Element 8: wherein the second reactor is not a stir reactor and the third reactor is not a stir reactor.
Element 9: wherein the volume ratio of the first reactor to the second reactor to the third reactor is (1-30):(12-24):(12-24).
Element 10: wherein the first reactor, the second reactor, and the third reactor each have a reactor length to diameter ratio from 20:1 to 100:1.
Element 11: wherein the zeolite catalyst comprises a silica to alumina molar ratio of 3 to 6.
Element 12: wherein the zeolite catalyst has an average particle size from about 500 nm to about 900 nm.
Element 13: wherein the zeolite catalyst has a crystallinity of at least 90% as measured by an X-ray diffraction (XRD).
Element 14: wherein the zeolite catalyst has a surface area of at least 500 m²/g.
Element 15: wherein the zeolite catalyst has a pore volume of at least 0.5 mL/g to 0.7 mL/g.
Element 16: wherein the zeolite catalyst has an average pore size from 2.0 nm to 5.0 nm.
Element 17: further comprising calcining zeolite crystals obtained from the third reactor at a calcining temperature of 300° C. to 600° C.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method of producing a zeolite catalyst, comprising:
mixing a basic solution with an aluminum/silicon mixture to form a basic aluminum solution, the aluminum/silicon mixture comprising a silicon source and an aluminum source;
feeding the basic aluminum solution into a first reactor to form a hydrogel, at a temperature from 20° C. to 40° C. for a residence time from 1 hour to 30 hours;
crystallizing the hydrogel in a second reactor to form zeolite crystals at a temperature from 50° C. to 70° C. for a residence time of 12 hours to 24 hours; and
transferring the zeolite crystals to a third reactor having a third reaction temperature of 80° C. to 100° C. for a residence time of 12 hours to 24 hours.

2. The method of claim 1, wherein the first reactor is a continuous stir reactor.

3. The method of claim 1, wherein the basic solution comprises a metal hydroxide.

4. The method of claim 1, wherein the basic solution comprises a molar ratio of hydroxide ions to aluminum to silicon (5 to 20):(1-3):(10-30).

5. The method of claim 1, wherein the basic solution comprises sodium hydroxide.

6. The method of claim 1, wherein the basic solution does not comprise an ammonium cation.

7. The method of claim 1, wherein the aluminum/silicon mixture comprises Al(NO₃)₃ or Al(SO₄)₃ and silica or a silicate.

8. The method of claim 1, wherein the residence time in the first reactor is from 18 to 30 hours.

9. The method of claim 1, wherein the second reactor is not a stir reactor and the third reactor is not a stir reactor.

10. The method of claim 1, wherein the volume ratio of the first reactor to the second reactor to the third reactor is (1-30):(12-24):(12-24).

11. The method of claim 1, wherein the first reactor, the second reactor, and the third reactor each have a reactor length to diameter ratio from 20:1 to 100:1.

12. The method of claim 1, wherein the zeolite catalyst comprises a silica to alumina molar ratio of 3 to 6.

13. The method of claim 1, wherein the zeolite catalyst has an average particle size from about 500 nm to about 900 nm.

14. The method of claim 1, wherein the zeolite catalyst has a crystallinity of at least 90% as measured by an X-ray diffraction (XRD).

15. The method of claim 1, wherein the zeolite catalyst has a surface area of at least 500 m²/g.

16. The method of claim 1, wherein the zeolite catalyst has a pore volume of at least 0.5 mL/g to 0.7 mL/g.

17. The method of claim 1, wherein the zeolite catalyst has an average pore size from 2.0 nm to 5.0 nm.

18. The method of claim 1, further comprising calcining zeolite crystals obtained from the third reactor at a calcining temperature of 300° C. to 600° C.
